(19) United States
(12) Patent Application Publication
(10) Pub. No.: US 2008/0296887 A1
(43) Pub. Date: Dec. 4, 2008

(54) Identification Card and Method for the Production Thereof

(76) Inventor: Emil Baggenstos, Urdorf (CH)

Correspondence Address: SUGHRUE MION, PLLC, 2100 PENNSYLVANIA AVENUE, N.W., SUITE 800, WASHINGTON, DC, 20037, US

(21) Appl. No.: 11/659,120

(22) PCT Filed: Oct. 27, 2003
(86) PCT No.: PCT/CH2003/000701

§ 371 Date: Feb. 20, 2007

(30) Foreign Application Priority Data
Oct. 29, 2002 (CH) 1812/02

(51) Int. Cl. B42D 15/00; B41J 2/01

(52) U.S. Cl. 283/109; 347/101

(57) ABSTRACT

The invention relates to a safety document (11) comprising at least one paper layer (4) coated with a transparent plastic layer (2, 3, 6, 7, 13) on the two surfaces thereof. The inventive method makes it possible to produce an identification card which embodied in a particularly simple and safe form since the paper layer (4) consists of a safety paper containing at least one safety characteristic (5, 8, 10, 15, 16) and the plastic layers (2, 3, 6, 7, 13) are made of a thermoplastic material which is melt in such a way that a transparent envelop (13) is produced exclusively by a high pressure and/or at a high temperature.

### TECHNICAL FIELD

The present invention relates to a security document with at least one paper sublayer, both sides of which have been covered, in each case by a transparent plastics layer, and also to a process for production of this security document, and to a use of this security document.

### PRIOR ART

Plastics cards for use as identification cards, members' passes, drivers' licenses, police passes and military passes, or credit cards mostly have a single- or multilayer structure and are composed, by way of example, of polycarbonate. Typically, a plastics card of this type has been provided with a print applied in the form of a thermal print or laser print (e.g. laser engraving). Multilayer plastics cards usually have a core component, both sides of which have been covered with layers composed of plastic.

In particular in the pass sector, the recent trend is increasingly toward plastics cards of the type which has been used for quite some time now in the context of credit cards. Pass documents which were previously issued on paper with the personalized data applied by writing with a typewriter or a matrix printer, etc. and with a picture applied by adhesive in the form of a photo, are increasingly being converted to plastics cards. By way of example, plastics cards in the form of pass cards are now in existence in a plurality of states for drivers' licenses, personal travel passes, or identity cards, etc. Particular security features present on these plastics cards are security prints, holograms, or kinegrams (the appearance of which changes as a function of the angle of viewing). Machine-readable codes may also be present, examples being magnetic strips (such as those conventional in credit cards), chips, transponders, or barcodes. In order to provide an additional security component for providing adequate counterfeiting security, personalization data have been applied to cards of this type in relatively complicated processes, such as laser engraving, in which a laser is used for writing on a central layer of the card. To this end, this layer has to be appropriately activated, i.e. there have to be specific admixed components activatable by way of the laser. Although there is usually reluctance to use paper in plastics cards, particularly because paper is easily damaged by moisture, there has been previous use of multilayer plastics cards in which a supporting layer composed of plastic has been provided with at least one paper layer, in particular provided on both sides with paper layers, adhesive-bonded to the core component composed of plastic. These paper layers are relatively thin when compared with the supporting layer which is composed of plastic and gives the card its stability, and they serve for application of a print. These cards are therefore easier to print, in particular by means of an ink-jet printer. After the print has been applied, the paper layer and the applied print arranged thereon is often protectively covered by means of an outer layer, in particular by means of a cold- or hot-laminated foil, in order to protect the applied print from wear or removal, and this outer foil may also have a hologram or guilloche print, etc. applied as a security feature. Cards of this type have also previously been used as simple pass cards when there are no particularly stringent security requirements, for example as club cards or the like. Cards of this type have not previously been regarded as suitable for pass cards with high security standards, in particular pass documents issued by national governments, because of possible counterfeiting.

### SUMMARY OF THE INVENTION

The invention is therefore based on the object of providing a novel security document, in particular for use as identification card, credit card, drivers' license, police pass or military pass, or members' pass, which can be produced simply and at low cost and at the same time has high security, in the context of security documents with at least one paper sublayer, both sides of which have been covered, in each case by a transparent plastics layer.

This object is achieved when the paper sublayer is a security paper with at least one security feature, and the plastics layers are a thermoplastic material which has been fused solely with use of elevated pressure and/or of elevated temperature to give a transparent sheath, where, at least in one or more sections, there is a marginal region in which plastics layers on both sides of the paper sublayer immediately adjoin one another.

The core of the invention therefore consists in the capability of using, directly for the plastics cards aspect of the safety documents sector, the security-features technology well known from the security papers sector (banknotes, checks, equity documents, etc.). These two sectors (security papers and, on the other hand, plastics cards) are traditionally different sectors which always use their own security-features technology. Simple and low-cost production of an inventive security document is provided by converting a security paper with appropriate security features to give, in some senses, a plastics card, via incorporation via fusion into a thermoplastic matrix. Firstly, this thermoplastic matrix assumes the functions of protection of the embedded paper sublayer(s), and secondly this matrix also provides the stiffness usually required. There is therefore no need for any further central plastics support. The marginal region of this matrix or transparent sheath moreover has a zone in which, at least in one or more sections, no paper sublayer is present. In other words, in this region this transparent sheath or plastics layer has been designed to assume the entire thickness of the card. Unless this marginal region is provided, a security document surrounded by plastics layers can to some degree be separated in the center by slitting the paper sublayer in the center parallel to the plane of the paper, with breakdown of the internal cohesion of the paper sublayer. Without a sealed marginal region this is readily possible in particular because the plastics layers applied act as levers and thus permit cleavage of the paper layer when a very small load is applied. This type of cleavage is readily possible in particular in the case of coated, finely milled papers with fine fibers (ink-jet papers usually being examples of papers of this type). These inventive fused marginal regions and the fusion of the substrate (security paper) to the plastic make cleavage of the paper almost impossible. The result is an enormous increase in security. The security document may be a credit card, for example, or an identification card, or a members' pass.

Another substantial feature of the method here proposed for achieving the object is that there is in principle no need for the use of adhesives or adhesion promoters to produce adhesion between the plastics layer and the paper sublayer, or between the plastics layers (in the marginal region). Specifically, although the paper layers and thermoplastics layers have very different chemical behavior (engineering thermoplastic on the one hand and cellulose on the other hand) they can to some extent be fused to one another, whereupon the paper layer is embedded to some extent in the plastic.

In other words, this is not actually a lamination process, but rather a process of fusion or incorporation via fusion, because, in particular if the polymers used on both sides of the security paper are identical, no layer structure can then be discerned in this matrix.

A fact which is very particularly worthy of mention in this connection is that even polymers without an actual melting point, e.g. polycarbonate or highly amorphous polyamides, give this type of laminate structure on heating above their glass transition temperature and on application of pressure. Polycarbonate (Makrofol ID 6-2 from Bayer, DE) is therefore also used in one preferred embodiment, and a highly amorphous polyamide (e.g. Grilamid TR90 from Ems Grivory, CH) is used in another preferred embodiment.

Specifically, there are many problems with the use of adhesives, whether in the form of heat-activatable adhesives or in the form of other systems as known from the prior art. By way of example, the use of plastics layers which have an adhesive layer on the side facing toward the paper typically produces clouding in the transparent layer after the lamination process, the clouding probably being attributable to the altered interface between adhesive layer and plastics layer (foils). This cannot occur in the present instance, because the lamination process involving the preferably identical plastics layers produces a homogeneous plastics block which cannot give rise to any such interfacial effects.

However, the omission of adhesives in particular also has technical consequences related to security. Specifically, if the plastics layers used comprise adhesion promoters or adhesives, the result is naturally layer structures in which the various layers (adhesive, plastics layer) have different physical and chemical properties. These different properties can be used to separate these layers from one another.

By way of example, if a normal heat-activatable adhesive is used, this typically has a melting point or glass transition temperature which is comparatively low, typically in the range from 90° C. to 120° C. Alongside this, however, there is a plastics layer with a melting point or glass transition temperature which is normally substantially higher, e.g. above 140° C. This difference can be utilized by counterfeiters in order to separate the layer structure, and this can be achieved without irreversible residual damage to the plastics layers. Accordingly, a system devizing embedding of a paper between two plastics layers of which at least one has an adhesive layer on the inner side can readily be separated, and there is only limited capability for prevention of counterfeiting.

In contrast to this, it is preferable in the present instance to use exclusively plastics layers whose flow point or melting point or glass transition temperature is above 120° C., preferably above 140° C., and particularly preferably in the range from 150° C. to 180° C. The lamination process or fusion process therefore accordingly forms a block which is composed of plastic and is substantially chemically and physically homogeneous and which then has no layer structure which could be utilized subsequently for separation by counterfeiters.

Another resultant advantage is that if exclusive use is made of plastics layers of this type with a high flow point the paper becomes substantially more deeply embedded into the plastics layers under the production conditions required. Penetration of the thermoplastic composition into the paper takes place during this process, whereupon an extremely stable and intimate bond is produced between paper layer and plastics layer, making subsequent separation of paper and plastic, or breakdown of the paper structure, practically impossible. Furthermore, the product is a card whose stiffness complies with current standardized requirements placed upon cards, and which cannot be achieved when using adhesion promoters.

The other problem frequently arising with use of adhesives, delamination on intensive use, can moreover be eliminated entirely, a circumstance attributable firstly to the stronger bond between plastic and paper and secondly to the fact that the plastics layer is not composed of different materials. When adhesives or adhesive layers are used, the paper becomes embedded only into the adhesive layers, which are mostly very thin, and this again reduces counterfeiting security.

The plastics layers are preferably in essence identical foils, i.e. foils with approximately identical physical properties. In particular, exclusive use is made of foils composed of identical material, thus producing a block which is composed of one thermoplastic and which is actually homogeneous. The melting point or glass transition temperature of the innermost layer, i.e. the layer which, of the plastics layers arranged on each side of the paper sublayer, faces immediately toward the paper, is therefore identical with the corresponding melting point or glass transition temperature of the outer layers if more than one layer composed of plastic is used for the production process on one side of the paper sublayers. In particular, the melting point or glass transition temperature of the innermost layer is not lower than that of plastics layers arranged so as to be more external.

If semi-amorphous or highly amorphous polyamides are used, for example those supplied by Ems Grivory (CH), it is possible, or indeed advantageous for the purposes of the invention, to combine various types. By way of example, two outer sublayers composed of one type of polyamide (e.g. Grilamid TR 90 from Ems Grivory, CH) may be laminated or fused to a frame sublayer of a second type of polyamide (e.g. Grivory G21 from Ems Grivory, CH) to give a solid composite. Both of these types are highly amorphous polyamides which do not have an actual melting point but merely have a glass transition temperature, and give the inventive practically inseparable bond which cannot be achieved with conventional adhesives, e.g. hotmelt adhesives.

In this specific instance, it can be advantageous for the glass transition temperatures of the various sublayers to differ, particularly if long process times are needed to laminate identical sublayers because the viscosity of the polymer is high. A polymer of this type which continues to have high viscosity above the glass transition temperature can be bonded rapidly with the aid of at least one inner sublayer or frame sublayer composed of a polymer whose viscosity at the processing temperature is lower, with little exposure of the internal security document to heat. This instance, where two different types of polymer are bonded to one another, also gives an intimate bond, unlike the bond obtained with the aid of an adhesive. The excellent bonding of various types of polyamide with, to some extent, very different thermal, optical and mechanical properties is a characteristic of this class of polymer.

For the purposes of the invention, it is possible to obtain a particularly high-performance product if, by way of example, two highly transparent outer sublayers composed of a highly amorphous polyamide are bonded to inner sublayers of a high-toughness polyamide, e.g. Grilamid 55 LY from Ems Grivory (CH). The elastomer-like inner sublayer permits production of a product which performs substantially better under flexure and impact than a product composed of sublayers all of which have substantially similar mechanical properties.

The security feature may in principle be security features from the safety papers sector. In other words, examples of those which may be used are: watermarks in the paper sublayer, security elements embedded at least in part or in one or more sections in the paper sublayer, e.g. in particular security strips or variously colored fibers, planchettes, etc., RFIDs, chips or magnetic strips applied to the paper sublayer, security prints applied to the paper sublayer, in particular in the form of an applied fluorescent print (if appropriate with polarizing properties), or of barcodes, or of an applied intaglio print. It is very generally possible to use what are known as OVDs, i.e. optical variable devices, e.g. holograms or kinegrams, which may have been applied in the form of foils, as patches or strips. Use may also be made of security strips with additional features, such as security writing, applied fluorescent prints or coatings, etc. Combinations of these security features mentioned can, of course, also be used. Other possible devices are taggants (e.g. in the form of up-converters; an example of a system which may be used is an anti-Stokes system using, by way of example, LUMILUX Green UC-2 from Honeywell), irising coatings or applied prints, see-through registration, and applied micro- or nanoprints.

In one first preferred embodiment of the inventive security document, the thermoplastic material is preferably transparent thermoplastic polycarbonate (PC), or else transparent thermoplastic polyamide, polyester, polyethylene terephthalate (PET), polybutylene terephthalate (PBT), polyvinyl chloride (PVC), polymethyl methacrylate (PMMA), acrylonitrile-butadiene-styrene copolymers (ABS), polyethylene (PE), or polypropylene (PP), or a mixture or different sublayers thereof. The plastics layers on each side of the paper sublayer together with the paper sublayer typically have a thickness (total card thickness) which is at least 0.5 mm to preferably at least 0.7 mm. By way of example, plastics layers of about 100-200 μm or indeed 300 μm may be used on each side, and paper layers of thickness about 200-500 μm may be used.

This type of security document retains a transparent zone in the marginal region, at least in one or more sections. In order to compensate for the thickness of the paper, another preferred embodiment of the invention permits design of the document in such a way that the size of the paper sublayer is somewhat smaller than the plastics layers which surround it on both sides, so that, at least in one or more sections there is, a remaining transparent marginal region at the margin, and that one or more further frame sublayers composed of plastic have been arranged in this marginal region, and have an inner stamped-out region into which the paper sublayer has been fitted. Because this type of transparent marginal region in one or more sections does not always meet the optical requirements based upon a plastics card, it is possible to color this marginal region specifically. One way of achieving this, if no frame sublayer is used, is to modify appropriately at least one of the two plastics layers in the region of the otherwise transparent margin. However, this can be achieved in a particularly simple manner specifically by using one or more sublayers of plastic for a frame sublayer, and making this frame sublayer from appropriately colored or modified plastic, so that the card then has uniform appearance across its entire area, complying with those of the known credit cards or identity cards.

Another preferred embodiment of the present invention, which is of particular interest in connection with security strips or watermarks, and moreover can provide a specific form of security not known in the sector of conventional credit cards or identity cards manufactured exclusively from plastic is achieved by designing the paper sublayer such that the security document is to some extent translucent at least when viewed in front of a light source. Plastics cards such as credit cards of the prior art are namely normally non-translucent, and accordingly these plastics cards also have no security features specifically related to the transparency of the card.

Another preferred embodiment of the present invention is characterized in that at least one side of the paper sublayer has an applied print, in particular applied by means of an ink-jet printer, in particular in the form of a photo and/or personal details. This simple way of personalizing this type of security document makes its production particularly simple and inexpensive. Typically, security papers used for the paper sublayer are accordingly those which by this stage have a coating which makes these security papers suitable for printing by an ink-jet printer. Care should be taken here that the inks used are such that when they interact with the coating during the process of production of the card (melting of the plastics layers) they do not exhibit any adverse effects, such as running, smudging, etc. During the printing process, ink penetrates deeply into the paper or the coating, and since, as previously mentioned above, ink-jet papers will readily split (paper cleavage), the use of ink-jet technology further increases security.

Other preferred embodiments of the inventive security document are described in the dependent claims.

The present invention also provides a process for production of a security document as described above. A feature of this process is that after the at least one paper sublayer (this usually being a security paper) has been personalized, in particular with the aid of an ink-jet printer, it is surrounded on both sides, in each case by at least one, but preferably by a plurality of, plastics foils, preferably composed of polycarbonate or composed of preferably highly amorphous polyamides, and this layer structure is fused with solely use of pressure and/or of elevated temperature to give a transparent sheath in essence enclosing the paper sublayer on all sides, without further assistance of adhesives. This process produces, in the marginal region, zones in which the plastics sublayers have been fused to one another over the entire thickness of the card.

In a process which has proven advantageous here, a combination of elevated temperature in the range below the glass transition temperature of the plastic used and pressure of more than 10⁶ Pa (e.g. in the region of 1.5×10⁶ Pa) is used for the fusion process, and a specific profile is particularly preferably traversed here in relation to pressure and temperature. By way of example, in the case of polycarbonate, the temperature in a laminator is first increased to the region of about 160 degrees Celsius, the pressure is then increased to the region of 1.4×10⁶ Pa, and then the temperature is lowered to about 120 degrees Celsius, and then the pressure is again increased somewhat to the region of 1.5×10⁶ Pa or indeed 1.57×10⁶ Pa.

As previously mentioned at an earlier stage above, it has proven advantageous to use one or more transparent or colored frame sublayers in addition to the plastics foils around the paper sublayer. In order to obtain maximum precision of card outline, after the fusion process to give the sheath in the laminator, the security document should also be stamped to give its final form.

Other preferred embodiments of the inventive process for production of a safety document are described in the dependent claims.

The present invention also provides the use of a security document as described above as a credit card, an identification card, or a members' pass.

### BRIEF EXPLANATION OF THE FIGURES

The invention will be further illustrated below using inventive examples in connection with the drawings.

FIG. 1 shows sections through inventive security documents, where a) shows a section through a security document prior to its fusion with, respectively, a single plastics sublayer and with embedded security element, and b) shows a corresponding section using a plurality of plastics sublayers on each side, and also with a security feature applied by printing or applied by adhesion, and c) shows a corresponding section using two frame sublayers and using a watermark in the paper sublayer, and d) shows a section through a finished, i.e. fused, security document; and

FIG. 2 shows plan views of inventive security documents, where a) shows a card with peripheral margin and b) shows a card with toothed margin.

### METHODS OF WORKING THE INVENTION

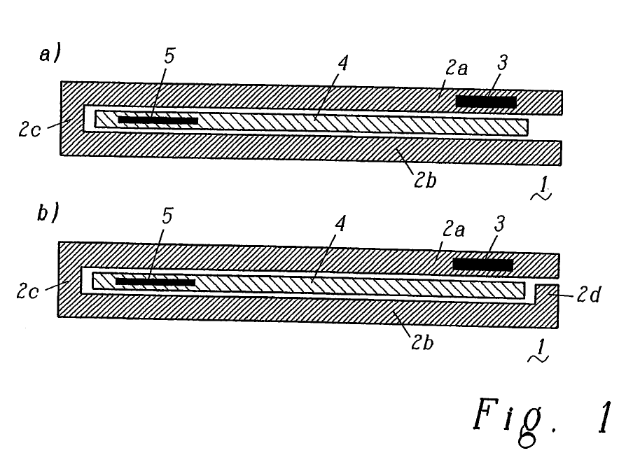

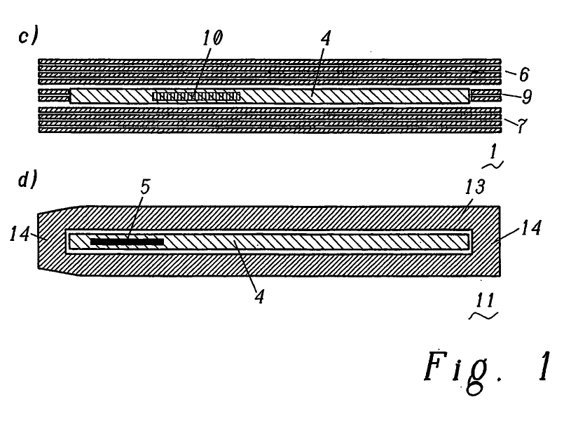

FIG. 1 shows various inventive examples, where each of FIGS. 1 a) to c) shows sections through unfinished identification cards in which the plastics layers arranged on the two sides have not yet been fused.

FIG. 1a) shows the simplest inventive example. A paper sublayer 4 is placed between two transparent layers 2 and 3. The upper transparent layer 2 and the lower transparent layer 3 are in this instance a single plastics layer. The two plastics layers 2 and 3 are larger than the paper sublayer 4, and each of the two plastics layers therefore protrudes over the paper sublayer 4 at the margin. On fusion, the plastics layers 2 and 3 are fused directly to one another in this marginal area.

In the inventive examples of FIG. 1a) to c), in each case the plastics layers 2 and 3 are shown as having substantially their final dimensions by this stage. Of course, it is also possible to introduce the two layers as a continuous tape or a strip or web, and to stamp out the finished cards only downstream of the laminator. The same applies to the paper sublayer 4, which also can be introduced as a strip or tape, but this will be described at a later stage below.

The plastics layers are preferably polycarbonate. However, other thermoplastics are also conceivable and possible, examples being polyethylene, polypropylene, ABS, or the like. In principle, the plastics layers 2 and 3 have to be layers composed of a thermoplastic which permits fusion of the layers at temperatures and pressures at which no damage occurs during the laminating or fusion process to the paper sublayer 4 or to applied prints or security elements present in or on the paper sublayer. In other words, the glass transition temperature of the thermoplastics layers should typically be below about 150-180 or 200 degrees Celsius, polycarbonate therefore being just within the acceptable range. Of course, at least one of the two plastics layers should be transparent, so that the information applied to the paper sublayer 4 or the security elements arranged in or on the paper sublayer 4 remain visible after the fusion process. In other words, the juncture at which the plastics layer introduced necessarily has to be transparent is not prior to the fusion process but rather after the fusion process to give a sheath surrounding the paper sublayer.

The plastics foil used for the purposes of the inventive examples given here comprised a polycarbonate foil obtainable from Bayer, DE with the name Makrofol ID 6-2. The thicknesses used here were 50μ, 100μ, 150μ, and 300μ. In order to permit provision of the required thickness in an inventive example of FIG. 1a), a polycarbonate foil of this type of thickness 300μ was correspondingly used on each side. Specifically, if the intention is to use this type of card as an identity card, the card has to comply with international standard, and specifically the ISO/IEC 7810 standard, which specifies, inter alia, that the thickness of this type of identification card has to be 0.76 millimeters, the tolerance being in the range +/−0.008 mm. Another feature of polycarbonate making it suitable in relation to this standard is that it permits compliance with the required stiffness (cf. section 8.1.1 of ISO/IEC 7810). The plastics foils may, if appropriate, also have polarizing properties. These should, as far as possible, also be substantially retained after the lamination process if the corresponding security effect in combination with fluorescent security ink located thereunder is to be observable (“flip-flop” effect with rotating polarization of the incident UV or IR light).

For the purposes of the present invention, it is also very generally possible to produce the card not by providing plastics foils on both sides for the fusion process but by embedding the security paper into an environment (with a relatively high or relatively low level of free-flow properties) composed of granulated plastic (e.g. PC), and then fusing the same with exposure to pressure and heat to give a solid matrix. To this end, the card is placed in a mold to which granulated material is previously or subsequently charged, and this material is then fused in a laminator or fusion apparatus, with pressure and/or heat.

The paper sublayer 4 is a security paper with at least one security feature, preferably with a combination of a plurality of security features. The paper sublayer 4 should be printable by an ink-jet printer, i.e. it should have coatings which make the substrate capable of absorbing and fixing inks of this type. The particular paper used in the present instance had a coating known as Digisafe from Landqart, CH. The weight of the paper per unit of surface area was 90 g/m². Very generally, it is found that for high security the paper should, as far as possible, be sufficiently thin that the ink penetrates through a substantial portion of the paper thickness, thus making paper cleavage more difficult. However, on the other hand, the paper must, of course, still be sufficiently thick to be capable of providing the required opacity and the required printing properties.

In the example of FIG. 1a), the paper sublayer 4 has a security feature which is a security element 5 embedded into the paper sublayer. An example of this can be a security strip (e.g. a plastics strip with a vapor-deposited metallic sublayer, and fluorescent colors may also have been incorporated here, if appropriate) which is either inserted into the paper pulp in such a way that it does not reach the surface of the paper sublayer 4 at any point, or else as what is known as a “window” strip, which appears at one or more surfaces, in one or more sections. Security strips of this type and their embedding into the paper are well known from the banknotes sector. Variously colored fibers may also be used.

FIG. 1b) shows a section through an appropriate inventive example in which, however, the plastics layers 2 and 3 are not now individual sublayers but rather have multilayer structure. In this specific instance, four foils have been mutually superposed as plastics layer 6 and, respectively, 7 on each side of the paper sublayer 4. An example of the thickness of the individual layers here is 100μ. In the inventive example of FIG. 1b), the paper sublayer 4 has a security feature which is a security element 8 applied by printing or applied by adhesion. An example of this security element is an applied security print, as known from the field of banknotes. Correspondingly, use may be made of an intaglio print, prints with fluorescent or phosphorescent security inks or, respectively, pigments, or of microprints, barcodes, or the like.

Examples of security features which may be used as an alternative or additionally are taggants, irising prints, planchettes, microprints, etc.

Other possible security elements 8 as shown in FIG. 1b) are elements applied by adhesion or otherwise to the paper sublayer 4, e.g. kinegrams, holograms, chips, magnetic strips (which can, however, also be subsequently applied externally), RFIDs (radio frequency induced devices). Care sometimes has to be taken here that these security elements are not damaged during the fusion or lamination process, i.e. the plastics used have to comprise those whose glass transition temperatures are appropriately low and which can be fused at appropriately relatively low pressure, but whose glass transition temperatures nevertheless are higher (typically >120° C.) than that of any commonly used hotmelt adhesive, because otherwise no true fusion of the matrix can take place.

In addition to these security elements applied to the paper sublayer 4, the invention permits introduction of additional security elements which are needed for checking purposes or for satisfactory functioning of a transparent substrate. Examples of these security elements are foils with polarized absorption and/or emission, dichroitic mirrors, color filters, UV-absorbent filters, special-effect grids, etc. By way of example, these may be introduced in the frame sublayer or in a recess of the paper sublayer.

FIG. 1c) shows another inventive example in which, in addition to the two plastics layers 6 and 7 extending across the entire surface, a specific frame sublayer 9 has been arranged (or in this specific instance two). This frame sublayer 9 has a central cut-out into which the paper sublayer 4 has been fitted with maximum precision. The purpose of this type of frame sublayer 9 can firstly be to prevent thinning in the region of the edges during the laminating process as a consequence of the fact that no paper sublayer is present in this marginal region. On the other hand, it is also possible to color this frame sublayer 9 or to use a specifically colored or non-transparent plastic for this purpose, so that in those marginal regions in which the paper sublayer 4 does not extend as far as the outer edge of the finished card the entire card does not appear transparent.

FIG. 1c) indicates diagrammatically a watermark 10 as security element. This is a particularly preferred security element in connection with the present invention, because it is not yet used in connection with conventional plastics cards, is very difficult to imitate, and represents what is known as a “human feature”, i.e. a security feature which can be verified directly by the naked eye, e.g. by holding the material up to the light, without the aid of specialized apparatus. The watermark 10 is particularly preferably the type known as a grey-level watermark, which can only be produced under specific conditions and using specific papermaking machines, and which is known from the security papers (in particular banknotes) sector.

The layer structures of FIGS. 1a) to c) are fused in a lamination process to give the actual identification card 11 shown in FIG. 1d). The example given here relates to a card of the thickness 0.76+/−0.08 mm, as required by the ISO standard. For this, the layer structures are exposed in a laminator to an elevated pressure and an elevated temperature, the temperature and the pressure preferably being adjusted so as to reach the region of the glass transition of the plastics foils used. It is preferable to traverse specific profiles, and by way of example in the present instance, using polycarbonate, the temperature was first raised to 157.7 degrees Celsius and then kept steady for about 50 seconds, and then the material was cooled by a fan for about 50 seconds, and then an elevated pressure of about 1.42×10⁶ Pa was applied, and then the material was cooled to about 120 degrees Celsius at constant pressure, and then the pressure was again further increased to about 1.5×10⁶ Pa or indeed 1.57×10⁶ Pa. Finally, the material was cooled to 30 degrees Celsius and the laminator was reopened. A laminator from the company Oakwood, US, was used in this specific instance. The cards were subsequently die cut in order to obtain a clearly defined circumferential edge.

In FIG. 1d) a slight reduction in the thickness of the card is visible on the left-hand side in the region of the edge 14. This type of thinning can occur if no use is made of any frame sublayer 9, which compensates for the absent paper sublayer 4 at the margin. The edge region shown on the right-hand side is ideal. For technical imaging reasons, FIG. 1d) shows a gap between paper sublayer 4 and the fused sheath 13, but the lamination process actually gives an intimate bond between the paper layer and the plastics foils. During the laminating process, plastic enters the paper fibers or the coatings of the paper sublayer 4 and to some extent anchors the sheath 13 to the paper sublayer 4. Accordingly, after lamination it is impossible to separate a plastics layer from the paper sublayer without paring away at least portions of the uppermost layer of the paper sublayer with the plastics layer. The result is inherently higher security of this type of identification card. Another possible security feature using current technology consists in specific stamped features in the paper sublayer (if appropriate consequences of holes forming a text or forming numerals), into which the plastics layers then penetrate during the fusion process.

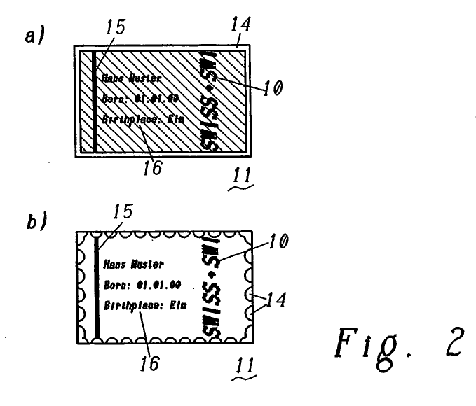

FIG. 2 shows plan views of inventive examples. FIG. 2a) shows an identification card which has a peripheral transparent margin 14. In the region of this peripheral margin 14, the sheath 13 has been completely fused, and accordingly it is also almost impossible, unlike in conventional adhesive-bonded or glued cards, to separate the upper and the lower plastics sublayer from one another and thus possibly to make duplicates of this type of identification card. The identification card 11 has a security strip 15 inserted into the paper, and also has a watermark 10 which, like the security strip 15, is discernible in particular on viewing through the material. The identification card also has an applied print 16 with which the card has been personalized. This applied print 16 is generated, by way of example, by an ink-jet printer prior to lamination. In addition, or on the other side, a color photo may also be applied by printing, as, of course, also may other information appropriate to correct use.

FIG. 2b) shows an inventive example in which the transparent margin 14 is not fully peripheral. Here, the paper sublayer has a toothed margin, analogous to a postage stamp. Accordingly, there are sections with transparent marginal regions 14. These marginal regions 14 can, of course, be colored, so that the card is then seen to have no transparent region at all. The toothed margin has the advantage that this type of paper sublayer with appropriate prestamping (analogous to a sheet of postage stamps) can be introduced in undivided form, in the form of a web. This type of paper web can be printed in undivided form, and then covered on both sides by one or more plastics layers, and then passed through a laminator. The resultant area then merely requires registered stamping to give the individual cards 11.

In principle, the following advantages result from the proposed procedure when comparison is made with the prior art:
The prior art typically uses a plastics card in which the personalization is carried out by means of laser engraving. This requires an activated polycarbonate layer which can be inscribed by means of a laser beam. The proposed card, in contrast, simply uses security paper to which a security print or the like has been applied. Personalization is achieved by means of ink-jet. Inscription by means of laser engraving does not per se provide any additional security, because this can be imitated via a laser copier or laser printer. In the case of the laser-engraving card, security has to be introduced by way of additional elements, such as OVDs. In the case of the ink-jet of the present invention, the ink can, by way of example, also be altered with respect to standard inks, making it difficult to imitate. Possibilities are:
   UV- or IR-active components
   color shading
These can be checked by simple instruments, e.g. a UV lamp, or by an OCR-B reader, or are simply visible to the naked eye. The paper can be protected from manipulation via introduction of reactive dyes which bring about a color change after use of bleaching agents (ink killers), acids, solvents, or alkalis, and this protection cannot be provided in a card composed purely of plastic. A great advantage of the ink-jet printer is its ability to print colored images with excellent photographic quality. Laser engraving can provide only black-and-white images with relatively low resolution.
For the sheath, the prior art fuses polycarbonate to the activated layer. In contrast to this, in the present instance the paper in the form of an inlay in a polycarbonate layer is fused to other polycarbonate layers. In the case of the card proposed with the security paper core, which in itself is intrinsically a highly secure document, as used in passes, for example, all of this is additional to the capabilities of the card made purely of plastic. There are no restrictions in this respect. Still further obstacles to the counterfeiter can be incorporated via particular design of the marginal region of the foil which comprises the security paper. This region can also be printed in color, thus permitting any desired variations in design. Tests have shown that it is very difficult to separate the paper/plastic combination, firstly because the plastic is fused to give a unitary body and no longer has an obvious layer structure, and secondly because the ink penetrates deeply into the paper during the printing process and moreover diffuses into the plastic during the fusion process. It is also difficult to manipulate one layer, because the original image always remains, and is therefore visible, on the other layer. This considerably increases the cost for the counterfeiter. A laser-sensitive layer can also be incorporated concomitantly in the newly developed card, thus permitting subsequent inscription by this technology, if this is desired.
The surface of a plastics card of the prior art typically uses security features comprising holograms, kinegrams, perforations, specific printing technologies, embossments, tactile features, etc. Since the card proposed here has the same surface finish as a plastics card of the prior art, there are no restrictions in comparison with the card made purely of plastic. The security features introduced within the paper, for example the watermark, the thread, the variously colored fibers, etc. are visible through the card and are very highly effective security elements. This permits supply of cards with better protection at substantially lower costs. If, nevertheless, these surface features are desired, it is possible to produce cards which have an incredibly high level of security. It has to be remembered that security is firstly determined via the quality of the security features, but secondly is increased greatly, indeed “exponentially”, by a combination of different features. When different technologies are tightly interwoven and employed in a very confined space, there is an extremely marked increase in cost for the counterfeiter. Manipulation of the document or indeed total counterfeiting consequently becomes so difficult as to be no longer economically viable.
The proposed cards are also at least equivalent to the prior art when they are equipped with data carriers. By of example, magnetic strips can either be applied to the paper sublayer or else preferably applied only to the finished outer side of the card.

### KEY

1 Identification card, not yet bonded
2 Upper transparent layer
3 Lower transparent layer
4 Security paper
5 Security element embedded into 4
6 Upper transparent layer having multiple sublayers
7 Lower transparent layer having multiple sublayers
8 Security feature applied to 4 by printing or by adhesive bonding
9 Frame sublayer around security paper
10 Watermark (shown diagrammatically)
11 Finished identification card
12 Oblique marginal region
13 Transparent sheath, fused
14 Transparent marginal region
15 Security strip
16 Applied print
17 Toothed margin

What is claimed is:

1. A security document (11) with at least one paper sublayer (4), both sides of which have been covered, in each case by a transparent plastics layer (2, 3, 6, 7, 13),
characterized in that
the paper sublayer (4) is a security paper with at least one security feature (5, 8, 10, 15, 16), and the plastics layers (2, 3, 6, 7, 13) are a thermoplastic material which has been fused solely with use of elevated pressure and/or of elevated temperature to give a transparent sheath (13), where, at least in one or more sections, there is a marginal region (14) in which plastics layers (2, 3, 6, 7, 9, 13) immediately adjoin one another, and where the plastics layers (2, 3, 6, 7, 13) encompass exclusively thermoplastic material with a glass transition temperature above 100° C.

2. The security document (11) as claimed in claim 1, characterized in that the plastics layers (2, 3, 6, 7, 13) have been fused without further assistance of adhesion promoters such as adhesives to give a sheath (13).

3. The security document (11) as claimed in any of the preceding claims, characterized in that the plastics layers (2, 3, 6, 7, 13) are composed of one and the same thermoplastic material.

4. The security document (11) as claimed in any of the preceding claims, characterized in that the plastics layers (2, 3, 6, 7, 13) encompass exclusively thermoplastic material with a glass transition temperature above 120° C., particularly preferably in the range from 140 to 200° C.

5. The security document (11) as claimed in any of the preceding claims, characterized in that it is a card for identification and/or authentication of the carrier with, if appropriate, subsequent issue of right to access or right to acquisition, and in particular is a credit card, an identification card, an access card, or a members' pass.

6. The security document (11) as claimed in any of the preceding claims, characterized in that the security feature is a watermark (10) in the paper sublayer (4) or is a security element (5) embedded at least in part or in one or more sections within the paper sublayer (4), e.g. in particular a security strip (15) or variously colored fibers, or is a OVD, RFID, or chip, or magnetic strip (8) applied to the paper sublayer (4), or is a security print applied to the paper sublayer (4), in particular in the form of an applied fluorescent print (8) or of an applied intaglio print (8), or is a combination of these security features.

7. The security document (11) as claimed in any of the preceding claims, characterized in that the thermoplastic material is preferably transparent thermoplastic polycarbonate (PC), or else transparent thermoplastic polyamides, polyphthalamides, polyester, polyethylene terephthalate (PET), polybutylene terephthalate (PBT), polyvinyl chloride (PVC), polymethyl methacrylate (PMMA), acrylonitrile-butadiene-styrene copolymers (ABS), or a mixture or combination thereof.

8. The security document (11) as claimed in any of the preceding claims, characterized in that the plastics layers (2, 3, 6, 7, 13) on each side of the paper sublayer (4), and the paper sublayer (4) together have a thickness which is at least 0.5 mm to preferably at least 0.7 mm.

9. The security document (11) as claimed in any of the preceding claims, characterized in that the size of the paper sublayer (4) is somewhat smaller than that of the plastics layers (2, 3, 6, 7, 13) which surround it on both sides, so that, at least in one or more sections, there is a remaining transparent colorless or a remaining colored opaque, or a remaining colorless opaque marginal region (14) at the margin, and that one or more further frame sublayers (9) composed of plastic have been arranged in this marginal region (14), and have an inner stamped-out region into which the paper sublayer (4) has been fitted.

10. The security document (11) as claimed in any of the preceding claims, characterized in that the design of the paper sublayer (4) is such that the security document is to some extent translucent at least when viewed in front of a light source.

11. The security document (11) as claimed in any of the preceding claims, characterized in that at least one side of the paper sublayer (4) has an applied print (16), in particular applied by means of an ink-jet printer, in particular in the form of a photo and/or personal details.

12. A process for production of a security document (11) as claimed in any of claims 1 to 11, characterized in that, after the at least one paper sublayer (4) has been personalized (16), in particular with the aid of an ink-jet printer, it is surrounded on both sides, in each case by at least one, but preferably by a plurality of, plastics foils, preferably composed of polycarbonate, and this layer structure is fused with use of pressure and/or of elevated temperature to give a transparent sheath (13) in essence enclosing the paper sublayer (4) on all sides, without further assistance of adhesion promoters, such as adhesives.

13. The process as claimed in claim 12, characterized in that use is made only of plastics layers (2, 3, 6, 7, 13) composed of one and the same thermoplastic material.

14. The process as claimed in claim 12 or 13, characterized in that a combination of elevated temperature in the range below the glass transition temperature of the plastic used and pressure of more than 10⁶ Pa to 1.6×10⁶ Pa is used for the fusion process, and a specific profile is particularly preferably traversed here in relation to pressure and temperature.

15. The process as claimed in any of claims 12 to 14, characterized in that, in addition to the plastics foils (2, 3, 6, 7), one or more transparent colorless or transparent colored or opaque colorless or opaque colored frame layers (9) or a combination thereof are used around the paper sublayer (4).

16. The process as claimed in any of claims 12 to 15, characterized in that, after the fusion process to give the sheath (13), the security document (11) is stamped to give its final form.

17. The use of a security document (11) as claimed in any of claims 1 to 11 as a card for identification and/or authentication of the carrier with, if appropriate, subsequent issue of right to access or right to acquisition, and in particular as an identity card, a credit card, an identification card, an access card, or a members' pass.
